(19) United States
(12) Patent Application Publication
(10) Pub. No.: US 2016/0320021 A1
(43) Pub. Date: Nov. 3, 2016

(54) LIGHT DIFFUSION DEVICE

(71) Applicant: LELLAN, INC., Redwood City, CA (US)

(72) Inventors: Dean Ekkaia, Emeryville, CA (US); Richard Alfons Wimmer, Redwood City, CA (US); Frank Halasz, Santa Cruz, CA (US)

(73) Assignee: Lellan, Inc, Redwood City, CA (US)

(21) Appl. No.: 15/108,397

(22) PCT Filed: Feb. 10, 2014
(86) PCT No.: PCT/US14/15573

§ 371 Date: Jun. 27, 2016

(51) Int. Cl. F21V 7/00; F21V 7/04; G02B 5/02; F21V 7/22

(52) U.S. Cl. CPC F21V 7/0033; F21V 7/22; F21V 7/04; G02B 5/0284; F21Y 2115/10

(57) ABSTRACT

A light diffusion device is described that provides uniform light output from a surface. One embodiment uses a short ratio of device height to width of the surface. The diffusion device comprises a reflector with a light entry window, a reflective baffle, a novel shaped reflector, and a diffusion layer for light to exit through. Light travels primarily from the source to the baffle to the reflector, then to the diffusion layer. The reflector has a 3D diffuse reflector surface that is a typically evolved form near its center then smoothly morphs to a non-revolved, preformed shape near its corners. The diffusion device is free of refractive elements. In some embodiments the devices are placed adjacently, in an array, to form a tile or panel of programmable light sources. The baffle and reflector may be manufactured from a flat sheet. Multiple devices may have elements manufactured from monolithic material.

### CROSS-REFERENCE TO RELATED APPLICATIONS

This patent application claims the benefit of U.S. Provisional Patent Application 61/775,585, filed Mar. 10, 2013, by the same inventors, and is hereby incorporated by reference.

### TECHNICAL FIELD

The technical field of this invention is illumination devices. More particularly, the technical field is illumination devices that produce a uniform exit illumination from a flat field.

### BACKGROUND ART

Prior art optical diffusers generally suffer from one or more of the following deficiencies: poor ratio of width to height; input light comes from the side, for example for LCD screens; low optical efficiency; high weight; high cost; not suitable for placement of repeated elements in a grid of adjacent diffusers; poor diffusion performance; inability to provide light output to the edges of the device; or not suitable for manufacturing multiple diffusers at the same time.

Prior art includes: U.S. Pat. No. 8,496,361; U.S. Pat. No. 8,231,257B2; U.S. Pat. No. 6,449,439; WO2001058991; U.S. Pat. No. 8,292,473B2; U.S. Pat. No. 8,310,759B2; U.S. Pat. No. 8,212,966 B2; US 20110075410 (with family members CN102667324A, EP2470827A1, WO2011041097A1); U.S. Pat. No. 8,360,604 (with family member US20110075408); U.S. Pat. No. 8,288,943 (with family members CN101983436A, CN101983436B, EP2274778A2, US20110025192, WO2009125314A2, WO2009125314A3); U.S. Pat. No. 8,482,319 (with family members CN101652601A, CN101652602A, CN101652602B, EP2135000A1, US20100110675, WO2008120165A1); US20130070460; WO2013056516); US20130070460; WO2013056516; U.S. Pat. No. 8,506,103; US20110075410 (with family members CN102667324A, EP2470827A1); U.S. Pat. No. 8,360,604 (with family members US20110075408); U.S. Pat. No. 8,288,943 (with family members CN101983436A, CN101983436B, EP2274778A2, US20110025192, WO2009125314A2, WO2009125314A3); U.S. Pat. No. 8,382,319 (with family members CN101652601A, CN101652602A, CN101652602B, EP2135000A1, US20100110675, WO2008120165A1) US20130070460; WO2013056516; U.S. Pat. No. 8,506,103; U.S. Pat. No. 8,455,887 (with family members CN101846281A, CN101846281B, EP2233819A1, EP2233819B1, US20100244061); US20130010232 (with family member WO2012035798A1); US20130077345 (with family members CN102933894A, EP2581641A1, WO2011155537A1); US20120069579; EP2479480A1 (with family members CN102498336A, WO2011034178A1); WO2013018902 (with family members JP2013037788A, TW201307753A).

### Disclosure of the Invention

The optical diffusion device of this invention overcomes the weaknesses listed above. In a simple description of one embodiment, consider a square box, about five times as wide as it is high, where light enters from near the center bottom and exits uniformly and diffusely from the top. The light source may be an LED, such as a tri-color LED, with a control source that selects hue and brightness; the LED may be in the device, or under it, in our described orientation, with light entering the device, or the box, through a light entry window. A novel reflective baffle is placed over the light source, reflecting the light downward and outward. A novel primary reflector then reflects this light upwards, towards a diffusion layer, at the top of the box. The nature of the light source; the shape, size and material of the baffle; the shape, size and material of the reflector; and the material, thickness and position of the diffusion layer all work together to provide uniform, diffuse light at the top of the device.

In one embodiment, these diffusion devices are placed adjacently in a two-dimensional array. Elements of the array may be constructed from a monolithic material, improving manufacturability, tolerances, quality, uniformity of light, and cost. In an embodiment where one or more controllers set hue and brightness the same for multiple devices in the array, the array produces the appearance of a single, large area, “panel” of uniform light. In this application and embodiment, each device of this invention may be considered a pixel in the array.

Such arrays or sub-arrays may be a regular tile, which in turn may be assembled into an array of tiles, producing an even larger panel. Such a large panel may cover an entire wall, ceiling, floor, shelf or trade show booth surface. Thus, we may talk about pixels, or devices of this invention, in a tile, array, or panel.

A unique feature of some embodiments is the ability for such panels to function variably in a single installation as a work light, mood or ambient light, static programmable large-image display, or a dynamic image, pattern, or logo display. Prior art fails to provide the necessary light uniformity, cost, weight, or width-to-depth ratio for these applications.

Although the simple example above refers to a “bottom” and “top” of the device, any orientation is possible, and in many cases an orientation will be on a vertical surface, such as a wall, rather than the horizontal surface first described. A unique aspect of embodiments is the novel shape of the primary reflector. Since a preferred embodiment uses square devices, the 3D reflector surface starts out as a revolved shape near its center, near the light source or light entry window, then evenly and smoothly morphs into a “preformed,” non-revolved shape towards the corners of the square. A second novel aspect of the shape of the reflector is that, rather than being generally a portion of a sphere or a rotated parabola, as in the prior art, rather a point of inflection is in cross-sections, where the curve changes from concave to convex. It is indeed this novel shape that contributes to the uniform light output of the device.

Another unique aspect of embodiments is the unique shape of the baffle. The baffle surface is both diffuse and reflective, and has a convex shape facing the light source, to distribute over a wide angle the light from the source towards the primary reflector. The baffle is shaped and sized such that, in conjunction with the other elements of this embodiment, it does not generate a shadow or dim spot on the diffusion layer.

Preferred embodiments have a low profile, meaning a high ratio of width to height, where height is the direction of light entry and light exit from the device, and width is in the plane of the diffusion layer.

### BRIEF DESCRIPTION OF DRAWINGS

FIG. 1 shows a perspective view of one reflector.

FIG. 2 shows a perspective view from the bottom of a diffuser including ribs.

FIG. 3 shows a top view of one reflector.

FIG. 4 shows a bottom view of a diffuser including ribs.

FIG. 5 shows a cross section of one reflector with an integral light source.

FIGS. 6A and 6B show two perspective views of a baffle.

FIGS. 7A and 7B show two views of ribs.

FIG. 8 shows a side view of a reflector and a light diffusion device.

FIGS. 9A, 9B, 9C and 9D show four views of a reflector.

FIGS. 10A and 10B show two rendered views of a reflector.

FIG. 11 shows basic elements of a light diffusion device.

### BEST MODE FOR CARRYING OUT THE INVENTION

For a variety of optical devices it is desirable to achieve an area of light as uniform as possible, both in intensity and often color. Applications may be technical or ornamental. Most practical light sources are not uniform over a large area. For example, consider an incandescent filament or an LED. Prior art solutions to achieve some area of uniform illumination from such sources typically involved some combination of a reflector, a lens and a diffusion layer. The completed assembly might be known as a “diffuser,” “mixing chamber,” or “viewing box.” We generally refer to devices of the above purpose as diffusers.

Building a good diffuser is difficult. Prior art attempts were generally for specific needs for specific applications. For convenience in discussion only, we generally assume herein that light enters from the bottom of the device and exits upward, unless otherwise stated. It is understood that most devices, including those of the instant invention, may be used in any orientation. Devices that use lenses are generally tall. Devices that use reflectors are both tall and often have shadow areas. Devices that use total internal reflection (TIR), or other refraction elements, have both precision alignment requirements and generally work properly with light sources that are either a point source or a single color. Edge-lit devices require a substantial bezel. Simpler devices provide some diffusion, but the final diffuse illumination is not well uniform and often has one or more hot spots. Many prior art diffusers require precision manufacturing or precision assembly and are thus expensive. Many prior art diffusers do not provide good color uniformity—this is particularly true of diffusers that use refractive optics.

If the light source is a tri-color LED, there is an additional challenge, which is that, each of the three-color components of the LED: a red, green, and blue emissive element respectively, is physically distinct. For most optical diffusers using lenses, specular reflectors, or refractive optics the three colors will not well mix at all angles, or all exit points for the light, to form a pure desired color, such as white light.

For some applications it is desirable that the diffuser be both thin and light. Thin, in this context, means that the exit diffusion surface is located relatively close to the light source; or equivalently that the device has a high width-to-height ratio. Almost no prior art diffusers provide this feature.

Embodiments of this invention overcome many of the weaknesses described above of the prior art. One application of this invention is to produce a panel comprised of a grid of uniform illumination elements, or pixels. “Uniform,” in this application, means primarily that the light across a single element, or pixel, is uniform in both brightness and color over the surface of the pixel, and also over a range of viewing angles. Uniformity may be measured by the consistency of light emissivity at the exit surface of the diffusion layer, using a test area of between 0.1% and 1% of the area of the diffusion layer surface. Consistency in the range of plus or minus 0.1% to 5% of the average emissivity of the diffusion layer is desirable. Uniform also means that it is practical to create a grid, tile or panel of pixels where each pixel is uniform compared to the other pixels, or may be electronically calibrated to be uniform.

In this application we refer to one diffuser as providing light for one pixel. In some embodiments, multiple diffusers are used to create a “tile” comprising a grid of multiple pixels. In some embodiments, multiple tiles are placed adjacent to create a large panel comprising a large number of pixels.

Specific features of some embodiments are:
(i) minimum total thickness (distance from light source to exit surface);
(ii) minimum total assembly weight;
(iii) low manufacturing cost per pixel, while using reasonable manufacturing tolerances;
(iv) high efficiency, meaning that a maximum amount of light exits the diffuser relative to the total generated light from the light source.

The core of an embodiment of this invention is a “light-diffusion chamber.” The chamber comprises three key elements: a baffle, a primary reflector (or “reflector”) and a diffusion layer. Light enters the chamber through an entry window, or is located within the chamber, and then is mostly reflected by the baffle and then mostly reflected again by the reflector, then diffused by the diffusion layer as it exits the chamber. In a preferred embodiment, the reflective surfaces of the baffle and reflector are diffuse reflectors, rather than specular mirrors. This means that some of the light is reflected multiple times, following rather random paths within the chamber. In one embodiment, a Lambertian light source is either inside the chamber, or outside with light entering through the light entry window. Because of the Lambertian distribution pattern, some light goes directly to the reflector, without first reflecting off the baffle. Similarly, some light may go directly from the source to the diffusion layer. Similarly, some light may reflect from the reflector to another portion of the reflector. Similarly, some light is reflected back into the chamber by the diffusion layer.

In some embodiment the diffusion layer is non-uniform, such as having variable thickness, variable reflectance, or other optical characteristics that are non-uniform over its surface or through its interior.

Some embodiments include manufacturing the reflector, baffle, or both from a flat sheet.

Some embodiments include using a single monolithic piece as the diffuser for multiple, adjacent diffusion devices.

The shape of the chamber of embodiments may be any shape, including round or non-uniform. In a preferred embodiment we use for exemplary purposes, the chamber shape and the diffuser, and thus the pixels of larger tiles and panels comprising multiple diffusers, is square. Alternative embodiments suitable for tile and panel use include rectangular and variety of regular or irregular polygon shapes for the pixels.

It is useful to start this detailed description by describing in more detail the components of one exemplary embodiment. It is understood that the convenience of the specificity in this discussion in no way limits the breadth and generality of the invention as a whole.

Let us consider a light source for the diffuser comprising a tri-color LED comprising individual color-emitting elements of red, green and blue. In general, if the diffuser does a good job diffusing white light, when all three elements of the LED are on, the diffuser will also do a good job with other colors. We will also discuss square pixels in this exemplary embodiment approximately 5 cm measured side-to-side or about 7 cm measured corner-to-corner.

For convenience of this discussion of one or more embodiments, we place the base of the diffusion device on a horizontal surface with the entry window and the LED(s) in the center of the base, facing upward. The diffusion layer is at the top of the diffusion device. The baffle is located in between the LED(s) and the diffusion layer. The reflector is a 3D surface that is near the base close to the LED(s) then curves upward to end closer to the diffusion layer at the perimeter of the inside of the diffusion layer.

We refer to a “primary plane,” which is the plane of the base of the diffusion device. Light at “zero degrees” is normal to this plane, sometimes referred to as the optical axis of the LED(s).

The diffuse reflectance of the baffle and reflector should highly efficient, meaning that close to 100% of incident light, from any angle, is reflected, at some angle. The diffusion layer should be highly efficient, meaning that close to 100% of incident light from the interior of the chamber should be emitted at some angle at the exit surface of the diffusion layer, or reflected back into the chamber.

Suitable materials for both the reflector and the baffle are thermoplastic, such as White97™ F23, White98™ F16 from White Optics™ and Alanod™ Miro™. A suitable material is PVD-coated highly reflective aluminum. Surfaces may be aluminized, partially aluminized or anodized. Multiple surface layers or treatments, including optical coatings may be used. Numerous different surface textures, including micro-milling, are appropriate to implement a desired degree of gloss, smoothness, diffuseness, and scatter.

A suitable material for a light diffusing material is PMMA, which may be a standard plate or injection molded. Various surface treatments, including different types of roughness or patterns is appropriate in some applications.

The reflector and baffle may be manufactured from a flat sheet, using thermal molding, stamping, bending, forming or other operations, or in combination. Any coating may be applied before or after forming. Cutting may be via stamping, shear, scissors, die, laser, or other cutting operations.

Most of the light from the LED is directed upward. A significant fraction of this light, say 90%, or in the range of 50% to 99.9%, or in the range of 65% to 97%, is reflected downward by the baffle. This element has its curved reflective surface facing downward, generally towards the reflector. A small fraction of light is absorbed (0.1% to 2% in one embodiment).

Most of the light bounced from the baffle hits the reflector. Some of the light rays hit the LED(s), and some of the light rays hit the legs of the baffle.

Light rays continue to bounce around the interior chamber in this way, with a varying number of reflections, although most (>50%) rays are reflected twice, once by the baffle and once by the reflector.

In one embodiment the LED(s) are predominantly Lambertian emitters. However, in some embodiments there are three colored LEDs: red, green and blue, in one package. Thus, although each is primarily Lambertian, their optical axes are not co-axial. This can cause light of one color to be reflected more strongly ultimately towards one area of the diffusion layer, and another color to be reflected more strongly ultimately towards a different area of the diffusion layer. This can cause the final color of the light exiting the embodiment of this invention to have non-uniform color. A unique characteristic of embodiments is good final color uniformity at the exit surface of the diffusion layer. Color uniformity may be measured by measuring the primary color or color temperature in a small area, such a 0.1% to 5% of the total exit surface of the diffusion layer. Desired uniformity may be determined by having all such measurements within a predetermined range on the CIE chromaticity chart, such as within an area of 0.1% to 5% of the area of the chart, or alternatively the range of all such measurements within a predetermined number of nm for the color of each measurement, such as within 2 to 80 nm. (Alternative ranges include 0.1% to 1% and 2 to 20 nm.)

In some embodiments the surfaces of the reflector or baffle or the inside surface of the diffusion layer, in a cross-section, are not monotonic. Ridges, ripples, or other variations may be used for either strength or to improve the diffuseness of the light.

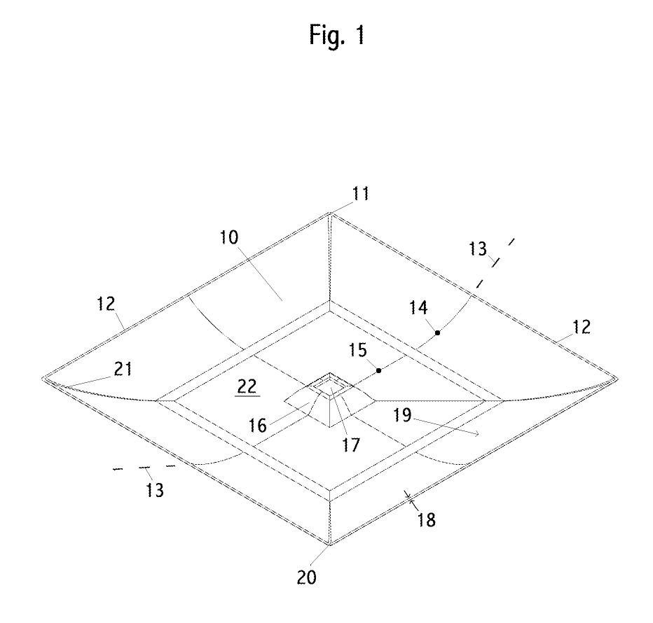

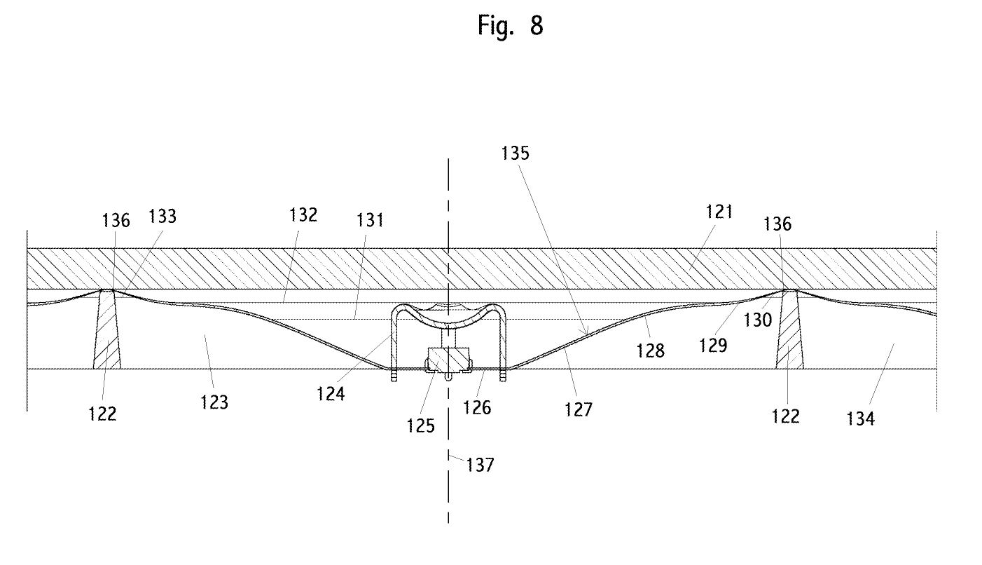

Turning now to FIG. 1, we see a perspective view of one embodiment of a reflector, 10. Note that the optically important part is the inward-facing reflective surface, 19. Note that this reflector is a surface, curved in three dimensions to form an upright, generally concave, bowl shape. One of four corners of a square shape is labeled, 11. The opposite corner is labeled, 20. The shape of the reflector may be square, rectangular, diamond, or hexagonal for close fitting of pixel elements within a tile or panel. Other shapes, including round, may be used for other embodiments and other applications. Two of four edges are labeled, 12. Line 13, labeled in two places, is a cross-section of the reflective layer through the center of two edges. Two points are identified, 14 and 15. Point 14 has a first radius and curvature (not explicitly shown). Point 15 on the cross-section is a second point located between point 14 and the center of the reflective layer, 17. At point 15 the reflector has a second radius and curvature (not explicitly show). In one embodiment the curvature is zero or concave at point 15 and convex at point 14. Along cross-section line 13-13 there may be more than one point of inflection (shown in FIG. 8 at the ends of line 132 and at 129 and again at 130). Note that a portion of the reflective layer may be flat, or have a linear slope (no curvature), or curved positive or negative. Note that a second cross section from corner 11 to corner 20 may have a significantly different shape than the first edge-to-edge cross section. Note that in this embodiment a crease near the upper corners is shown, 21. This crease line may or may not extend all the way towards the center of the reflector. For example, in this Figure, we see the crease line 21 does not extend into area 22.

Continuing with FIG. 1, we see a raised area 16. This raised area does not exist in all embodiments. We also see the light entry window, 17. In one embodiment one or more LEDS are located under the raised area 16. 18 shows the thickness of the reflector. Note that many of the lines in FIG. 1 are not components of manufactured or formed reflective layer, but rather are in this Figure to show or describe the shape of the reflector. Other variations of the shown reflective layer are possible, and many minor variations will function equivalently. For example, the crease 21 may be very sharp, somewhat rounded, or very rounded. Very rounded would be more similar to a round soup-bowl. Other deviations from the general bowl shape that function equivalently for the purpose of this invention are equivalents and should not be viewed as a departure from the literal words and claimed embodiment in a claim or from the disclosure herein. Shapes of other embodiments of the reflector are discussed more, below. Note that FIG. 1 does not show LEDs, a baffle, supporting structure, or the diffusion layer.

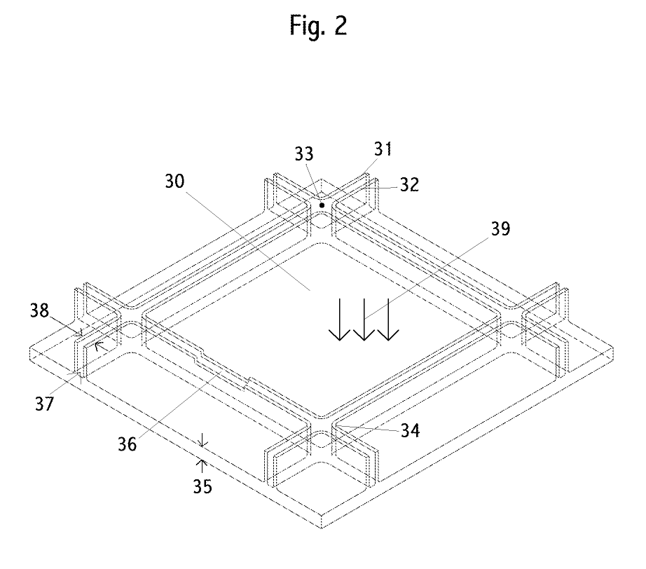

In FIG. 2 we see one embodiment for ribs located between pixels, or between light diffusion devices of this invention, which may or may not serve as a supporting structure for one or more elements of this invention. Note that in this FIG. 2 that ribs for more than one pixel are fabricated as a monolithic piece. 31 and 32 show parallel ribs. 38 shows the spacing between ribs. Although in this Figure ribs 31 and 32 are shown as two plates, they may be merged into a single plate. Although the ribs 31 and 32 are shown parallel, they may be tapered either towards or away from the sheet 30. The thickness of sheet 30 is shown as 35. In one embodiment, sheet 30 is the diffusion layer, and thus is at the “top” of a diffusion device, with the arrows 39 showing the direction of light as it enters the diffusion layer from inside the chamber. Thus, view of the Figure is upside-down from the reference orientation used in most of this document. In another embodiment, sheet 30 is a support sheet at the bottom of the chamber, and arrows 39 point away from the exit light direction. 36 shows an opening in one rib, which may be used to support a cable or circuit board between adjacent diffusion devices, or pixels. 34 shows an inside corner where two ribs meet. This curvature or chamfer is important in some embodiments, as a curvature radius that is too large will produce dark areas between pixel corners; while a curvature that is too small is difficult to manufacture and may product a hot-spot between the corners of adjacent pixels.

This FIG. 2 shows one complete pixel portion, plus portions of eight surrounding pixel portions. A planar portion of the diffusion material provides the majority of the effective light diffusion of the device in use, in one embodiment. The planer portion is shown at the end of line 30 and has its thickness shown as 35.

Portions of four ribs are shown in FIG. 2. The thickness of a rib is shown, 38. Each rib, in this embodiment, has two walls and a slot. Two exemplary walls are shown as 31 and 32. Looking into the slot is shown 37. A point at the intersection of two ribs is shown as the dot, 33. The walls 31, 32 and the slot 37 are used to avoid injection mold sag at the rib intersection points, 33. The rib walls have an interior chamfered radius on the inside of each pixel area, 34. This radius has both mechanical and optical advantages. An optical advantage is that some light enters the monolithic diffusion layer at the chamfer, providing ultimately more uniform light output and a smaller “dark area” where light exits at the intersection of the ribs. The chamfer radius range is described elsewhere herein. Ideally, the radius is adjusted for each embodiment or application such that light exiting the monolithic light-diffusive device is most uniform. The slot, 37, in the ribs has both mechanical and optical advantages. It helps avoid injection mold sag at the center of the ribs; it reduces injection mold sag at the intersection of ribs, 33; it reduces the total material requirement for the device. It provides a desired degree of mechanical compliance. And, it directs light entering the device from each pixel to optimally exit both uniformly for that pixel while mixing minimally with light from an adjacent pixel. In this Figure, the slot width is approximately half of the rib width. In this FIG. 2, the slot depth is the same depth as the ribs. Ideally, both slot width and depth is adjusted for each embodiment or application to optimize the uniformity of the light output while minimizing undesirable color mixing between pixels. Other slot dimension ranges are described elsewhere, herein.

FIG. 2 also shows a rib with a single region of less depth, 36. Such a region may be placed on any number of ribs, including all. The region may vary in dimensions for different ribs. In this embodiment, the purpose of the region of less depth is to provide clearance for a protrusion on a mating component in an assembled finished product or sub-assembly. In this embodiment, the length of the region of less depth is between a quarter and a third of the width of one pixel; the depth is between one-quarter and one-third the depth of the ribs. Significantly other dimensions, locations and shapes of such a region(s) of less depth are appropriate for different embodiments.

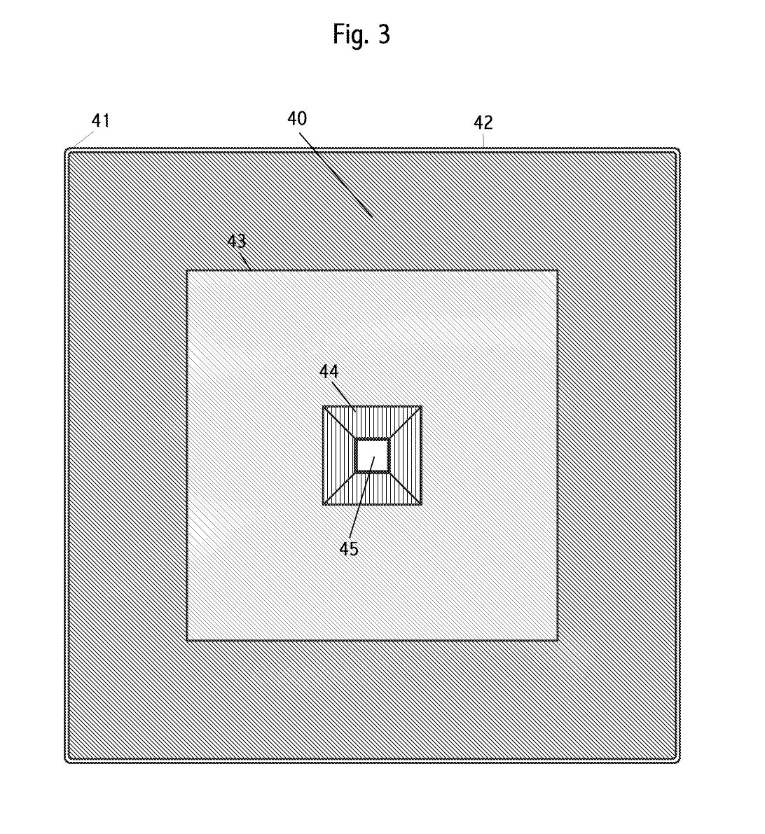

A perimeter wall along the outside of a complete, manufactured monolithic light-diffusive device is not shown in FIG. 3. In one embodiment, the thickness of the perimeter wall is one half the thickness of a rib; thus, one half of thickness 38 in FIG. 2. In one embodiment the perimeter wall has the same depth as the ribs, and no slot. In one embodiment the perimeter wall forms the function of a rib for the side(s) of all of the pixels that have at least one side on the perimeter of the monolithic light-diffusive device. Perimeter walls may or may not have a region of reduced depth, such as 36, with possibly different dimensions than the regions of reduced depth in the ribs.

In some embodiments, the ribs are formed as a monolithic element separate from any plane, such as shown as 30 in FIG. 2 with thickness 35.

The number of pixel elements in a complete monolithic light-diffusive device, or “tile,” may vary. In one embodiment, the tile comprises 36 square pixels in a 6×6 array. Other suitable array sizes are in the range of 2×2 to 256×256. Another suitable range of array sizes is 3×4 to 100×100. Yet another suitable range is 4×4 to 25×25. Yet another suitable range is 5×5 to 12×12.

FIG. 3 shows a top view of an embodiment of a reflector, 40, for one pixel. In this exemplary embodiment, each pixel is square. Reflective layers may be manufactured for a single pixel, a linear line of adjacent pixels, a group of pixel elements for a tile, such as a 6×6 array, or for more than one tile, out of a monolithic, or single piece of material. The individual reflectors in such a monolithic sheet may be rigidly joined by having a large fraction of the perimeter of a reflector joined to an adjacent reflector; or, adjacent reflectors may be flexibly joined by small points of connection. Either way, such a manufacturing process aids in reducing manufacturing cost, reducing manufacturing assembly labor, and assisting in precision alignment of reflectors with other components in the manufactured product. Such joining of adjacent reflectors in not shown in the Figure. 41 shows the corner of the layer corresponding to a corner of the corresponding pixel. 42 shows an edge of the layer corresponding to the edge of the corresponding pixel. 43 shows, for one embodiment, the place where the curvature changes as a point of inflection for a cross-sectional curve. Note that line 43 is not a visible line on an actual reflector, but is shown as a line in this Figure for clarity. In one embodiment, 45 is the light entry window, area 44 is flat, the area between line 43 and area 44 has a linear shape or a concave curve, and area 40 has a convex shape, or a more complex shape that might be initially convex near line 43, then morphing to a concave shape again at the perimeter 42. 41 shows a corner or the reflector, with a corner radius visible. Any creases near the corner 41 are not shown in this Figure. Note that this shape is a different shape and embodiment than the reflector shown in FIG. 1.

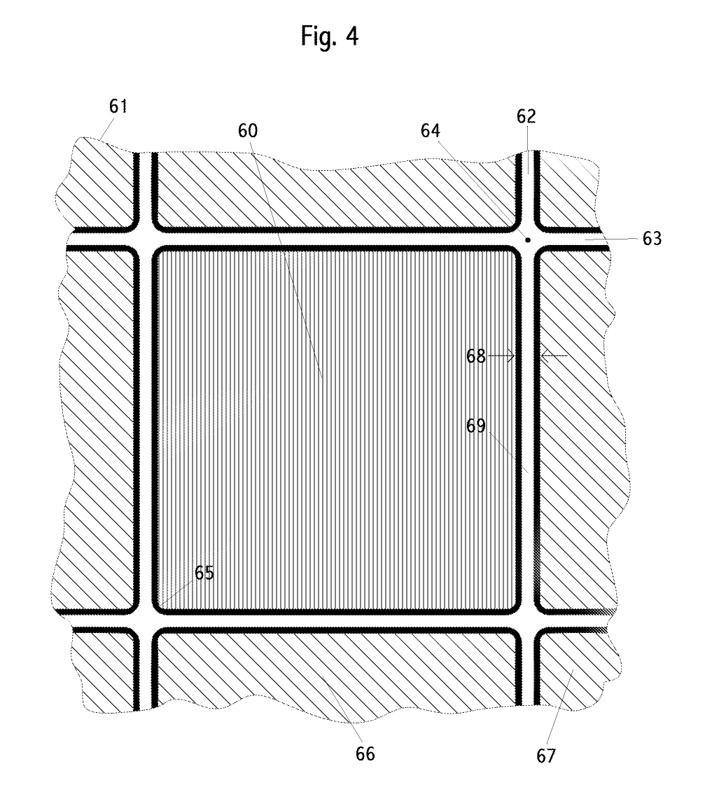

FIG. 4 shows a schematic view of a diffusion layer and ribs, where the diffusion layer or ribs or both are each or both manufactured as a monolithic element for more than light diffusion device. This simplified view looking either up or down, shows both ribs and diffusion layer, although often no such view physically exists. 60 shows the area of one light diffusion device, or pixel. The ragged perimeter, 61, emphasized that this is a portion of an array of multiple devices. One full pixel area is shown as the large vertically shaded square, 60, in the center of the Figure. Portions of eight surrounding pixel areas are shown by diagonal shading, such as 66 and 67. Portions of four ribs are shown. 63 labels one horizontal rib and 62 labels one vertical rib. Note that ribs 62 and 63 may be solid, hollow, slotted or grooved; and may be open or closed. The ribs may have a central slot, labeled 69 in one rib. The slots, if there are slots, are shown as white in the Figure; if there are not slots, the shown white area is the rib, with the dark lines being the sides of the ribs, which may be tapered. In this embodiment, the width of the rib is shown as 68. The center point where two ribs cross is shown as the dot, 64. The interior wall of the ribs at the corners of the pixels has a chamfered radius, shown as 65. Dimensions and ratios for the monolithic light-diffusive device are discussed elsewhere, herein.

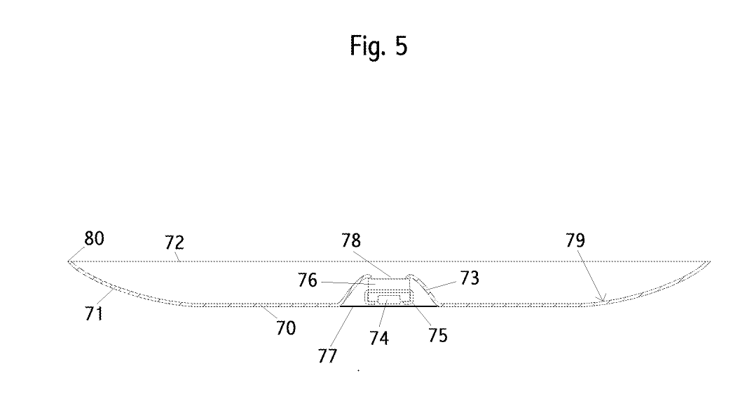

FIG. 5 shows a cross-section of one embodiment of a reflector. Note that the general shape of the reflector in this embodiment is an upright bowl. This Figure and embodiment does not show a reflector with one or more inflection points in its cross-section. 70 shows a portion of the reflector that is flat, or has a gentle curve, such as a large radius. 71 shows a portion of the reflector closer to the edges that has a curve, such as a smaller radius than area 70. Line 72 shows the uppermost boundary of the reflector: a plane intersecting as least a portion of the edges of the reflector. Line 72 is not part of the reflector. The reflector is shown as the hatched area. The Figure is not to scale. 73 shows a raised area of the reflector to accommodate an external light source below the reflector, but within the rectangular box of the “chamber” of this embodiment. This external light source is shown as 77, 74, 75, and 76. The external light source is not part of the reflector, but is part of an overall light emitting tile or light emitting panel, as one application of an embodiment encompassing only a diffusion chamber or diffusion device. 77 is a circuit board, on which is mounted an LED 74, in package 75, with an optical covering 76. The light from the LED (or other light source) enters the chamber through light entry window 78. Here, this is an opening in the reflective layer. In other embodiments, the light entry window may comprise material. The reflective surface of the reflector is shown as 79. Surface 72 shows the light entry surface of the diffusion layer. The diffusion layer is not shown.

Note in this embodiment shown in FIG. 5 that the bottom of the reflective layer, 70, is coplanar with a portion of the circuit board 77 that mounts the external light source. This novel design is particularly compact and also permits self-alignment in some embodiments between the reflective layer and the light source or the light source circuit board. 80 shows the outermost edge or tip of the reflector, in this cross-section.

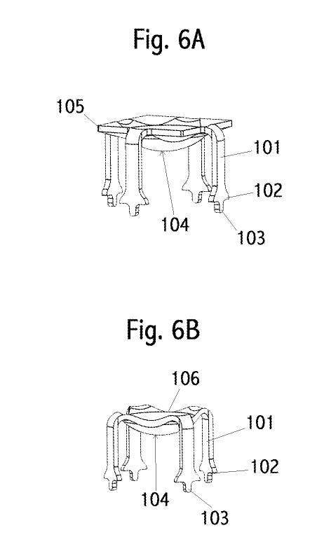

FIGS. 6A and 6B show isometric or perspective views of two embodiments of the baffle. The baffle has a curved reflective surface, 104. It has four legs, 101. Each leg has a foot, 102 and the foot has a pin, 103. The legs 101 hold the baffle at the desired height in the chamber. The feet 102 hold it at the correct angle and sit against the installation surface, which might be the reflector or a circuit board. Other embodiments use a different number of legs, from 2 to 24. The legs may be shaped to be reflective in a desired pattern. There is an advantage in having legs unaligned or of a different number than the sides of the device of this invention, so that any possible shadows or highlights from the legs are not aligned with the shape of the device, thus minimizing any apparent non-uniformity of illumination of the device. The pins 103 aid in manufacturing and alignment. For example, the pins 103 may be placed into corresponding holes in the reflector or a circuit board, with the feet 102 resting on that surface. In the embodiment shown in FIG. 6A the reflector has corners, 105. In the embodiment shown in FIG. 6B, the corners are replaced with recesses, 106. The selection of the corner shape, such as 105 or 106 or another shape or size is an important aspect of making the baffle such that the final light diffusion device provides uniform, diffuse light.

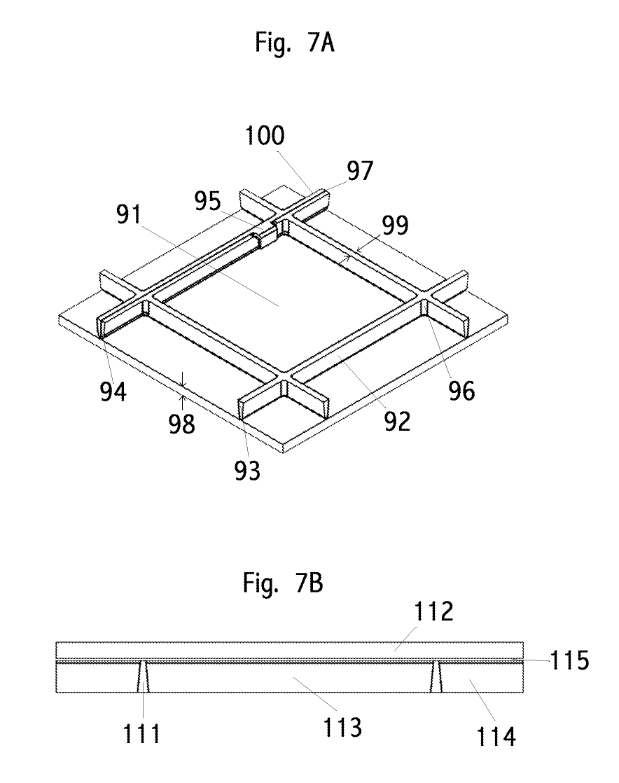

Looking now a FIGS. 7A and 7B we see an isometric view and cross section of one embodiment of ribs between light diffusion devices or pixels. The ribs, in this embodiment, serve two purposes. First, they are a key structural element of both individual light diffusion devices and also a tile comprised of multiple, adjacent light diffusion devices. Second, they block the light between adjacent pixels at the diffusion layer in a precise way such that the light from two adjacent pixels appears uniform at the border between the two pixels so that the overall light from a tile or panel is uniform and visually “seamless,” assuming that the light from the adjacent pixels is set to the same hue and brightness. The ribs, in one embodiment, also serve as a key spacer between the bottom and top of the chamber of the light diffusion device.

The view in FIG. 7A may be upside down, where layer 91 is the diffusion layer, or right side up where layer 91 is the base of the chambers of diffusion devices. We discuss an embodiment and view where layer 91 is the diffusion layer. 92 shows a sample rib element. Note that a monolithic piece may incorporate ribs between many pixels. Here all of one pixel area is shown, around 91, and portions of eight other pixels surrounding it. Two tiles may be adjacent, where each tile uses a monolithic piece to create all the ribs for that tile. This embodiment is shown in this figure with one monolithic piece being 92 and a second monolithic piece as 100, with 97 being the joint between the two monolithic rib pieces. 98 shows the thickness of the diffusion layer, in this embodiment. 96 shows a chamfer at an inside corner of two intersecting ribs within one monolithic rib piece. A unique feature of this embodiment is that the ribs are tapered, shown at 93 and again at 111 in FIG. 7B. This means that the rib thickness is thinner where the rib meets the diffusion layer 91. This tapering is a key aspect of an embodiment that creates a seamless appearance for multiple pixels in a tile of adjacent light diffusion devices. Another unique feature of an embodiment is that the ribs in the monolithic element are half the regular rib thickness at the periphery of the monolithic element, which is also the periphery of the tile. In this way, when two tiles are placed adjacent, and the two rib pieces placed adjacent the total rib thickness at this junction is then the same as the rib thickness within the tile. For example, interior rib thickness is shown as 99. At line 97, the junction of two adjacent tiles, each peripheral rib is half thickness and the total thickness is the same as at 99. 93 and 94 both show how ribs taper as they reach the diffusion layer. 94 shows that the taper is effectively the same, even at the junction of two adjacent tiles. 95 shows an embodiment of a mechanical element that connects two adjacent monolithic rib pieces.

FIG. 7B shows a side view of an embodiment of ribs between light diffusion devices. 113 is a side view of one light diffusion device, or pixel. 111 is an end view or cross-section of one rib. 114 is a portion of a pixel adjacent to 113. 112 is the diffusion layer. 115 shows an optional air gap between the top of the ribs 111 and the diffusion layer 112. In an alternative embodiment, 115 may be another diffusion layer. The transmissivity, diffusion, or reflection of layer 115 may be non-uniform. If 115 is a diffusion layer, then 112 may be also a diffusion layer or may be a protective or other purposed cover plate. Note in this Figure the tapered rib at 111.

FIG. 8 shows an embodiment of a reflector, and a side view in a light diffusion device. 121 is the diffusion layer. 135 is the reflector, with the 135 arrow head pointing to reflector surface. 136 identifies the two ends of the cross-section of the reflector for one light diffusion device. The Figure shows portions of two additional reflectors for adjacent light diffusion devices, sharing ribs with this device. In some embodiments the edge of the reflector 135 extends over the top of the ribs 122, rather than ending at the interior top corner of the ribs. In some embodiments the reflectors for multiple adjacent light diffusion devices are fabricated from a single sheet, and thus a portion of this monolithic element passes over the tops of ribs 122. 137 shows a centerline of the light diffusion device. 122 show two end views or cross-sections of two ribs. The cross-section in this Figure is through the center of two edges of a light diffusion device. 123 shows the chamber of the light diffusion device. 124 shows a cross-section of an embodiment of a baffle. Two legs and the baffle's reflector shape are clearly visible. 125 shows an LED, the light source in this embodiment. 126, 127, 128, 129 and 130 show different portions of the curve of the reflector in this cross-section. In this embodiment, the complex curve of the reflector is crucial in creating the uniform, diffuse light output of the light diffusion device, out through the diffusion layer 121. 126 shows a flat area near the LED and under the baffle. 127 shows a linear region or a region that is concave, or bowl shaped. 128 shows a convex region. 129 shows another concave region. 130 shows a linear or concave region with different curvature than region 129. Lines 131, 132, and 133 show where the curvature in this cross-section of the reflector passes a point of inflection. At height 131 in the chamber, the curvature changes from region 127 to region 128. At height 132 in the chamber, the curvature changes from region 128 to region 129. At height 133 in the chamber, the curvature changes from regions 129 to region 130. 134 shows a pixel adjacent to pixel 123. In one embodiment this drawing is properly proportioned. Other embodiments use different proportions.

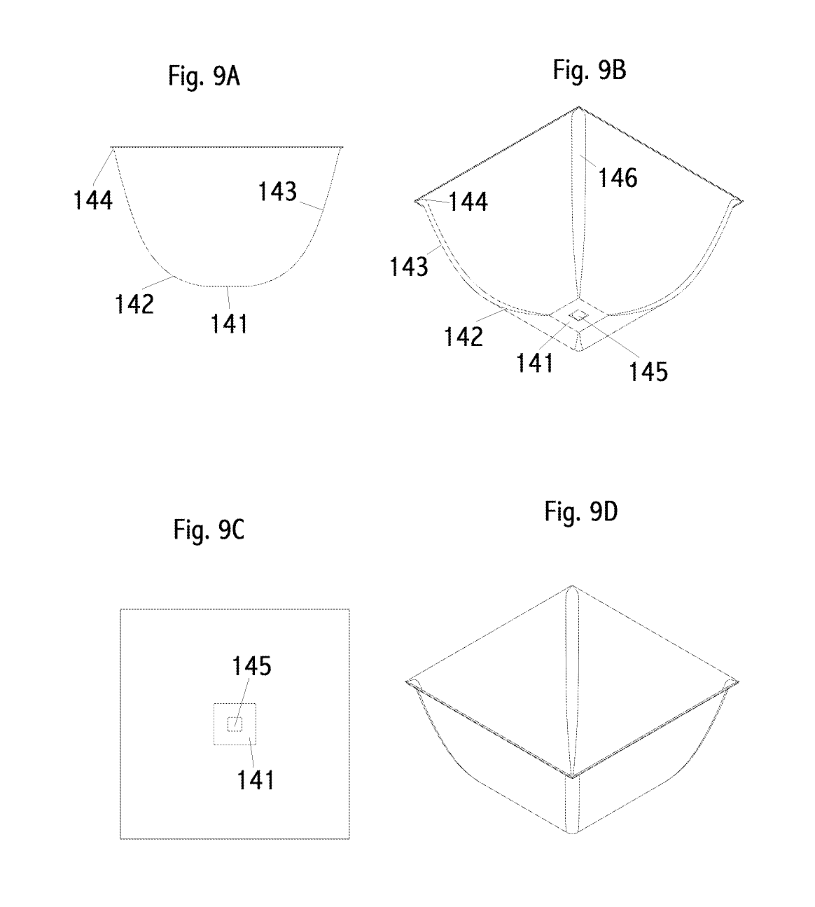

FIGS. 9A, 9B, 9C and 9D show four views in one embodiment of a reflector. 141 in all views shows a flat area near the center. 142 in all views shows a first area of curvature. 143 in all views shows a second area of curvature. 144 in all views shows a third area of curvature, closes to the periphery or top of the reflector. Note that in this embodiment there is a point of inflection between areas 143 and 144. 145 shows the light entry window. 146 shows and optional crease starting at the corners and moving towards the center. The shape and extent of the crease varies in different embodiments. FIG. 9A is a side view. FIG. 9B is a cut-away isometric view. FIG. 9C is a top view. FIG. 9D is an isometric view. None of these four views is to scale. Note that the reflector as a whole is generally a pre-form shape, not a revolved shape. It may have a revolved shape near the center, maybe or maybe not excluding the flat area and light entry window.

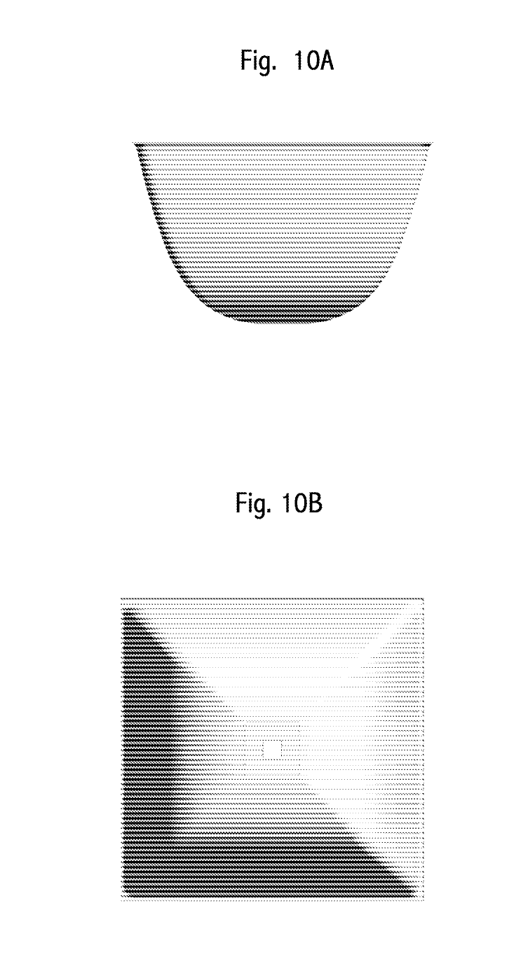

FIG. 10A shows a rendering of a side view of one embodiment of a reflector.

FIG. 10B shows a rendering of a side view of one bottom of a reflector.

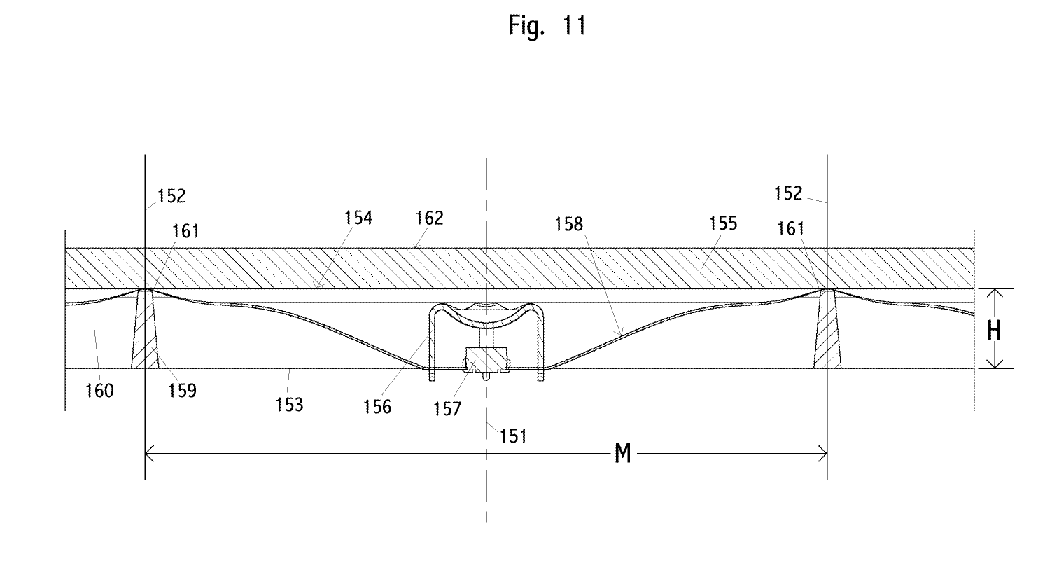

FIG. 11 shows basic elements of a light diffusion device, shown in a cross-section of one embodiment. The width of the device is shown as M, and the height of the device is shown as H. The base plane is 153. The light diffusion exit surface is 154; in other embodiments it is surface 162. This Figure shows a diffusion layer, 155. Not all embodiments have diffusion layers. The light diffusion exit surface may be above or below, or inside of the diffusion layer 155. 151 shows a centerline of the device. This Figure also shows an LED, as a light source, 157; not all embodiments include a light source, and not all light sources are LEDs. The baffle is shown 156. The reflector is shown 158, where the arrowhead on line 158 shows the reflective surface of the reflector. Lines 152 mark the edges of an enclosing polygon. For a volume V which defines a chamber of the device, 153 is the base plane, 154 is the top plane, and 142 are the sides. 159 shows a cross-section of rib; a second rib is visible in the Figure. Ribs are used to mechanically separate and support multiple adjacent light diffusion devices. Here, rib 159 is shared between two light diffusion devices: the primary one in the Figure and a portion of an adjacent device, 160. Note that in this embodiment the rib is tapered. The diffuse light exit surface, in this embodiment, is in the plane 154 and extends to two end-points shown in this cross-section as 161. Note that the end points 161 are just shy of the perimeter of the device, shown as lines 152. Thus, the area of the diffuse light exit surface is slightly smaller than the area of the base or top of the defining polygon, whose width is M.

A unique feature of this embodiment is the large M/H ratio, as shown in FIG. 11. This permits an array of these light diffusion devices to be arranged adjacently so as to form a tile. Such tiles may then be place adjacently to form a panel. In an ideal embodiment the light from the individual light diffusion devices, or pixels, is uniform across tiles and panels, so as to form a large seamless illuminated array. A large M/H ratio permits low-profile and low-weight tiles and panels to be constructed.

A novel feature of this embodiment is the selection of the sizes, shapes, locations and materials of the light source, baffle, reflector, ribs, and diffusion layer so as to create uniform light at surface 162 of FIG. 11. In particular that the light from the primary light diffusion device in FIG. 11 and the adjacent device, 160, merge above rib 159 within the diffusion layer 155, so as to exit at surface 162 with emissive uniformity across surface 162 between the primary light diffusion device shown and adjacent device 160. The tapered rib 159 contributes to this feature, as does the shape of the reflector 158 and the baffle 156. In some embodiments the reflector 158 in FIG. 11 is to scale; in other embodiments it is not. In one embodiment the baffle is 5 to 20 mm wide, and 3 to 12 mm high. In one embodiment the baffle is 10 mm wide and 6 mm high. In one embodiment the reflector is 25 to 100 mm wide, and 15 to 60 mm high. In one embodiment the reflector is 50 mm wide and 30 mm high.

Additional definitions and embodiment and claim discussion

A “light mixing cell” or a “light diffusion device” is an assembly of components, as described. The boundaries of the described polygonal volume (two parallel regular polygons, plus walls) are not necessarily comprised of any physical components, although one ore more boundary areas may comprise a physical element or a physical element may comprise one or more boundary areas. The described polygonal cell volume is a reference point for the physical components comprising the embodiment. For example, the reflector and semi-transmissive layers may be circular, enclosing a cylindrical or clam-shaped volume within the described polygonal volume. Ideally, the described polygonal volume is the smallest polygonal volume that encloses the embodied components of the light diffusion device.

The polygon may have any number of sides equal to or greater than three.

In one embodiment the polygon has six sides. In one embodiment the polygon has four sides.

A “polygon diameter” M is defined by the maximum distance from any corner to any portion of an edge or to another corner. That is, M is the maximum possible straight line inside the polygon.

A “light entry window” is an opening or group of openings in the reflector, through which light may enter the light mixing cell. Light does not have to originate in the light mixing cell. For example, an LED or other light source may protrude through the light entry window such that the light originates inside the cell. Light may also originate outside the light mixing cell. The window may be constructed of a material, such as a transparent or translucent layer, material, or assembly.

A “centering accuracy” of the light entry window may be in the range of 0.001% to 90% of the width M. Yet another range is 0.1% to 25% of width M. Yet another range is 1% to 5% of M. Yet another value for the centering accuracy is no greater than 5% of M. Yet another value for the centering accuracy is no greater than 20% of M. Centering accuracy means that the center of the light entry window is positioned is equal to or less than, plus or minus, measured in any direction on the plane from the ideal center of the polygon, the specified accuracy. For example, of M is 10 cm, and the centering accuracy is 20%, then the center of the light entry window must be located equal to or less than 2 cm distant from the center of the polygon.

An “exit surface area threshold” is defined as a ratio of the area of the second polygon. 100% would mean the exit surface area is the same as the area of the second polygon. A suitable range for the exit surface area threshold is 2% to 100%. A second suitable range for the exit surface area threshold is 50% to 100%. Yet another suitable the exit surface area threshold is 80% to 100%. A suitable value for the exit surface area threshold is 80%. Another suitable value for the exit surface area threshold is 90%. Another suitable value for the exit surface area threshold is 95%. Another suitable value for the exit surface area threshold is 98%. Another suitable value for the exit surface area threshold is 99%. In general, a larger exit surface area threshold provides for higher efficiency and more uniform final appearance of some applications and embodiments. An exit surface threshold close to 100% may present manufacturing challenges. If the exit surface is curved, the measurement should be for the projection of the exit surface onto the diffusion plane.

A “predetermined base distance” is the distance of the reflector layer from the base of the mixing volume. It may be measure in distance units such as mm. It may be measured as a percentage of the polygon width M or height H. It may be the minimum distance of the reflector layer to the base, or the average distance, using one definition of “average” known in the art, including numerical average, mean or mode. A suitable range for the predetermined base distance is 0% to 80% of H. Another suitable range for the predetermined base distance is 0% to 30% of H. Yet another suitable range for the predetermined base distance is 0% to 10% of H. A suitable value for the predetermined base distance is 0. Another suitable value is less than 1 mm. Another suitable value is than 10% of H. Another suitable value is than 1% of H.

The diameter M may be at least 9/3 H, or at least 8/3 H, or at least 7/3 H, 6/3 H, or at least 5/3 H, or at least ⅔ H, or at least one-half H.

A “reflector area threshold” measures the size of the reflector as a percentage of the maximum possible area. This area is roughly the base of the mixing cell volume minus the area of the light entry window. The area is practically reduced by manufacturing tolerances of the reflector, as it must fit inside the mixing cell volume (or comprise all or part of the base of the cell) while not blocking the light entering the light entry window. The area is practically increased by making the reflector bowl shaped such that some of the sides of the reflector extend upward along a portion or all of the walls of the volume. Thus, because reflector may not be flat, it may have an area larger than 100% of the area of the base of the mixing cell minus the area of the light entry window. If the cell is deep (H is large relative to M) the reflector could be considerably larger than the area of the base of the cell. The reflector area may be measure in multiple ways. One such way is to measure the projected area of the reflector onto the base of the light mixing cell: that is the projection onto the base plane. Another such way to measure the area of the reflector is to measure the entire reflective area of the reflector. Yet another such way to measure the area of the reflector is to include only those areas of the reflector that are effectively reflective, in the application used, above a threshold, such at least 25% or 50% reflective. In general, a larger reflector provides higher efficiency, subject to the shape, material, diffusion and other parameters of the reflector. A suitable range for the reflector area threshold is 50% to 500% of the (area of base of the mixing cell volume minus the area of the light entry window), hereinafter referred to as area AA. Another suitable range for the reflector area threshold is 75% to 150% of AA. Another suitable range is 90% to 120% of AA. A suitable value for the reflector area threshold is 90%.

A “semi-transmissive area threshold” may be measured as a percentage of the top of the light mixing cell volume V. That is, as a percentage of the area S. In general, a larger area of the semi-transmissive layer improves the efficiency of the light mixing cell. The semi-transmissive layer may be curved, in which case its area is measured as its projection onto the top of the mixing volume V. Thus, the maximum area possible is S. A suitable range of semi-transmissive area thresholds is 25% to 100%. Another suitable range is 75% to 100%. Another suitable range in 90% to 100%. Another suitable range in 95% to 100%. A suitable value for the semi-transmissive area threshold is 80%. Another suitable value for the semi-transmissive area threshold is 95%. The semi-transmissive layer may have curved edges to as to fit in a self-aligning way with within the light mixing cell. The edges of the semi-transmissive layer may bend downwards along the edges of the volume V.

The edges of the semi-transmissive layer may approach, touch, or overlap the edges of the reflector layer. They may overlap on the inside or the outside of the edges of the reflector layer.

A “predetermined light uniformity” refers to how uniform the light appears at different points on a surface, such as the surface of the semi-transmissive layer or a diffusion layer. Uniformity is measured, as those trained in the art know, by reading a quantity of light over a small measurement area, moving the measurement area over the larger area to tested, and comparing the differences in different readings over the area to be tested. Often, uniformity measurements are broken into “global” uniformity and “local” uniformity measurements.

Global uniformity refers to the entire larger area tested. Local uniformity refers to measurements taken within a certain distance of each other. Local uniformity may be defined for an area that is 1% or 10% of the global area, for examples. The equation that may be used for uniformity is 1−(max−min)/(max+min) where max is the maximum measurement and min is the minimum measurement taken over the area being tested. If max=min, then the uniformity is 1, or 100%. If max=2*min=2, then the uniformity is 1−[(2−1)/(2+1)]=67%. Maximum possible uniformity is 100%. This is sometimes said that the non-uniformity is 0%. One value of uniformity is 50%. Another value for uniformity is 80%. Yet another value for uniformity is 90%. Yet another value for uniformity is 95%. Yet another value for uniformity is 98%. The values for local uniformity and global uniformity may be different. For example, one pair of local and global uniformity values are 95% and 90%, respectively.

A “bowl shape,” for example for the reflector, is defined as a curve, in cross-section of the layer, wherein the curve has a smaller radius at the closest point to the nearest edge of the base or top polygon, than the radius in the center of the layer. This shape may be linear or flat (infinite radius) for an area near the center of the layer. This shape may have one or more wall areas that are straight and parallel to the walls of the polygonal volume.

A “crease” may be or may include a slit.

A predetermined continuity percentage for the continuity of the reflector or the reflector surface may be at least 50%, at least 60%, at least 70%, at least 80%, at least 90%, at least 95%, at least 98%, at least 99%, or 100%.

No actual orientation of the light diffusion device in use is implied by any terminology herein. In particular, embodiments of this invention are intended to be used in all orientations.

“An LED” is a reference to one LED, or to a group of LEDs. Thus, “an LED” comprises any number of LEDs.

Embodiments of this invention include all possible combinations of features and limitations in the claims. Embodiments of this invention include all functional combinations of features described or shown in the disclosure of this invention. All combinations and sub-combinations of all features, embodiments, claims and claim limitations are explicitly included as embodiments herein.

Ideal, Ideally, Optimum and Preferred—Use of the words, “ideal,” “ideally,” “optimum,” “optimum,” “should” and “preferred,” when used in the context of describing this invention, refer specifically a best mode for one or more embodiments for one or more applications of this invention. Such best modes are non-limiting, and may not be the best mode for all embodiments, applications, or implementation technologies, as one trained in the art will appreciate.

May, Could, Option, Mode, Alternative and Feature—Use of the words, “may,” “could,” “option,” “optional,” “mode,” “alternative,” “typical,” “ideal” and “feature,” when used in the context of describing this invention, refer specifically to various embodiments of this invention. Described benefits refer only to those embodiments that provide that benefit. All descriptions, examples, and scenarios herein are non-limiting, as one trained in the art will appreciate.

All examples are sample embodiments. In particular, the phrase “invention” should be interpreted under all conditions to mean, “an embodiment of this invention.” Examples, scenarios, drawings, applications, and claimed benefits herein are non-limiting. The only limitations of this invention are in the claims.

A suitable ratio for M/H is greater than one. Another suitable ratio for M/H is greater than 1.5. Yet another suitable ratio for M/H is greater than 2. Yet another suitable ratio for M/H is greater than 3. Yet another suitable ratio for M/H is greater than 5. Yet another suitable ratio for M/H is greater than 8.

“Near” the center, “near” an edge, or “near” a corner, means that the center of an area or region is within a predefined range, as a distance or percent of the diameter M of the light mixing cell or the diameter of the layer of discussion. Such a range might be in the range of 1% to 50%. Yet another range might be in the range of 5% to 30%. A suitable predefined range might be 25%.

For the monolithic diffuser: a suitable thickness for the pixel areas is in the range of 0.5 mm to 15 mm. Another suitable thickness for the pixel areas is in the range of 2 mm to 5 mm. A suitable thickness is 3 mm.

For the monolithic diffuser: “substantially constant width” for the ribs in the monolithic diffuser means that at least 50% of the ribs have a width that is plus or minus 50% of the average rib width. Ribs may have a cut-out section. That is, ribs may be comprised of two or more walls, or have a non-uniform height. A suitable range of rib width is 1 mm to 15 mm. Another suitable range is 2 mm to 5 mm.

For the monolithic diffuser: a suitable range for the slot cut in the ribs is 10% to 90% of rib width. Another suitable range is 25% to 75% of the rib width. A suitable width of the slot is 40% of the rib width.

For the monolithic diffuser: a “substantially constant width” for the perimeter wall in the monolithic diffuser means that at least 50% of the perimeter wall has a width that is plus or minus 50% of the average perimeter wall width.

For the monolithic diffuser: “substantially planer” means that the surface is on a plane plus or minus 25% of the thickness of the monolithic diffuser.

For the monolithic diffuser: “the second and third thicknesses are the same,” means the same within plus or minus 25%.

For the monolithic diffuser: “the width of the perimeter wall is substantially one half the width of the ribs” means one half within plus or minus 25%.

For the monolithic diffuser: “ribs have a slot along their long axis,” in one embodiment, the slot width is such that the width of the slot is one third (within plus or minus 25%) of the rib width and the two remaining walls of the ribs are then each one third (within plus or minus 25%) of the rib width. The slot depth may vary from 10% of the rib depth to 150% of the rib depth, provided that the slot does not penetrate the diffusion surface of the diffuser. On one embodiment the slot depth is the same as the rib depth, within plus or minus 25%. The base of the slot may be curved.

For the monolithic diffuser: “ribs have an interior chamfer,” means a radius in the range of 0.1% to 33% of the diameter of the pixel area. Another suitable radius range is 1% to 5% of the diameter of the pixel area.

For the monolithic diffuser: “a region of less depth” may have a length along the rib in the range of 1% to 90% of the length of one edge of the pixel area. Another suitable range for the length of region of less depth is 5% to 60% of the length of one edge of the pixel area. A suitable depth of the region of less depth is 1% to 100% of the depth of the rib. Another suitable depth for the region of less depth is 10% to 75% of the depth of the rib. In general, the region of less depth needs to be sufficient to allow clearance for the projection on the mating component for which it is intended, while small enough to maintain the structural integrity of the ribs and sufficient length of ribs for their intended mating or spacing purpose.

For the manufacturing of a semi-transmissive layer: “similar shapes” means shapes that have the same number of sides (if any) of each other, and have the same area within plus or minus 25%.

For the manufacturing of a semi-transmissive layer: “non-uniform” means a transmissivity at least 25% variance across the area. More detailed embodiments of the non-uniformity are described elsewhere herein.

Suitable range for the diameter of a pixel is 1 mm to 10 meters. Another suitable range for a pixel is 5 mm to 500 mm. A suitable value for a pixel diameter is 50 mm.

A suitable thickness for the thickness of the planar portion of the diffusion device is 0.1 mm to 100 mm. Another suitable range is 1 mm to 10 mm. A suitable value for the thickness of the planar portion of the diffusion device is 3 mm.

A suitable range for the thickness of a light diffusion device is 0.5 mm to 600 mm. Another suitable range is 2 mm to 100 mm. A suitable value for the thickness of a light mixing cell is 5.7 mm.

A suitable range for the M/H ratio of diameter to height of a light diffusion device is 0.5 to 50. Another suitable range is 2 to 20. Another suitable range is 5 to 12. Another suitable range is greater than 2. A suitable value for the M/H ratio is 8.

A suitable range for the rib thickness in a light diffusion device is 0.2 mm to 50 mm. Another suitable range is 1 mm to 10 mm. A suitable value for the rib thickness is 3.2 mm.

A suitable range for the width of a slot in a rib in a diffusion device is 10% to 90% of the rib thickness. Another suitable range is 25% to 75%. A suitable value is 50%.

A suitable depth for a reflective layer is less than 10 mm. A suitable depth for a semi-transmissive layer is less than 10 mm.

A suitable ratio for the width/depth of a reflective layer is greater than 2. Another suitable ratio is greater than 10.

A suitable ratio for the width/depth of a semi-transmissive layer is greater than 2. Another suitable ratio is greater than 10.

1. A light diffusion device, comprising a light entry portion, a light exit portion and at least one reflector, wherein light exiting the light diffusion device is of emissivity that is uniform within a predetermined light uniformity tolerance, wherein the improvement comprises:
a horizontal base plane;
a first regular polygon on the base plane with a polygon center, with P polygon edges and with P polygon corners, with an area S, and a polygon diameter M, wherein P is less than or equal to six;
a horizontal diffusion plane above and parallel to the base plane separated from the base plane by a diffusion plane height H;
a three-dimensional closed volume V defined by a base, a top and P sides, wherein the base is the first regular polygon, the top is a second polygon, identical to the first regular polygon, on the diffusion plane, and the P sides are vertical walls, each wall extending perpendicular to the base plane and to the diffusion plane connecting the edges of the first and second polygons;
a light diffusion device primary axis normal to the horizontal base plane centered in the regular polygon;
a light entry window at the center of the first polygon within a predetermined centering accuracy;
a diffuse light exit surface of area equal to or larger than an exit surface threshold area;
a reflector comprising a curved reflector surface, wherein the reflector surface is continuous within a predetermined continuity percentage, the reflector surface extending from the light entry window outward to the P sides of the closed volume V, and the reflector surface is disposed at the base of the closed volume V around the light entry window and disposed at the top of the closed volume V at the periphery of the reflector surface; wherein at least a portion of the reflector surface as it extends inward from its periphery is not a surface shape created by rotation of a two-dimensional curve around a reflector surface axis; and wherein the reflector surface as it extends inward from its periphery comprises a crease extending inward from each of P corners of the top of the polygon of volume V; and
a reflective baffle disposed within the volume V between the light entry window and the horizontal diffusion plane; wherein the baffle reflects at least a portion of the light from the light entry window towards the surface of the reflector;
such that at least a predetermined percentage of the light entering the light diffusion device through the light entry window exits the diffuse light exit surface with illumination uniform within the predetermined light uniformity tolerance.

2. The light diffusion device of claim 1, further comprising:
a monolithic light diffusion layer disposed below the horizontal diffusion plane such that the reflector surface is disposed at the lower surface of the light diffusion layer and the horizontal diffusion plane is disposed at the upper surface of the light diffusion layer; wherein lower is defined as towards the base plane and upper is defined as away from the base plane.

3. The light diffusion device of claim 1, wherein:
the light diffusion device, exclusive of any light source itself, is free of light refracting elements.

4. The light diffusion device of claim 1, wherein:
the reflective baffle comprises a reflective baffle surface facing the light entry window wherein the baffle surface is convex, facing the light entry window; and
a plurality of legs, wherein the legs penetrate the plane of the reflector surface and at least some of the light reflected from the baffle passes between at least two legs towards the reflector surface.

5. The light diffusion device of claim 1, wherein:
the reflector is fabricated from a monolithic flat sheet.

6. The light diffusion device of claim 1, wherein:
the reflector comprises P slits, each slit extending inward from the periphery of the reflector.

7. The light diffusion device of claim 1, further comprising:
a reflector cross-section from the center of a first reflector edge to the center of a second reflector edge opposite the first edge; and
wherein the reflector cross-section of the reflector surface comprises a first point of inflection between 50% and 90% of the distance from the center of the cross-section to an end of the cross-section.

8. The light diffusion device of claim 7, wherein:
wherein the reflector cross-section comprises at least a second inflection point.

9. The light diffusion device of claim 1, wherein:
the diameter M is at least 5/3 the height H.

10. The light diffusion device of claim 1, wherein:
the diameter M is at least ⅔ times the height H.

11. The light diffusion device of claim 1, further comprising:
P ribs disposed at the sides of the regular polygon, extending from the horizontal base plane to the horizontal diffusion plane, wherein the ribs are tapered with their narrower width proximal to the horizontal diffusion plane.

12. The light diffusion device of claim 1, further comprising:
P ribs disposed at the sides of the regular polygon, extending from the horizontal base plane to the horizontal diffusion plane, wherein the ribs for multiple adjacent light diffusion devices are monolithic.

13. The light diffusion device of claim 1, further comprising:
a diffusion layer proximal to the horizontal diffusion plane, wherein the diffusion layer for multiple adjacent light diffusion devices is monolithic.

14. The light diffusion device of claim 1, wherein:
the diameter M is at least ⅔ times the height H;
the baffle size is in the ranges of 5 to 20 mm wide, and 3 to 12 mm high; and
the reflector size is in the ranges of 25 to 100 mm wide, and 15 to 60 mm high.
